(19) United States
(12) Patent Application Publication
(10) Pub. No.: US 2012/0255716 A1
(43) Pub. Date: Oct. 11, 2012

(54) HEAT DISSIPATION DEVICE AND MANUFACTURING METHOD THEREOF

(76) Inventors: Wen-Yuan Wu, New Taipei City (TW); Chih-Chieh Lu, New Taipei City (TW)

(21) Appl. No.: 13/081,834

(22) Filed: Apr. 7, 2011

(51) Int. Cl. F28F 9/02; B23P 15/26

(52) U.S. Cl. 165/173; 29/890.052

(57) ABSTRACT

A heat dissipation device and a manufacturing method thereof. The heat dissipation device includes a first chamber defining a first cavity, a second chamber defining a second cavity, and multiple connection members each defining a passageway. First and second ends of the connection members are respectively connected with the first and second chambers in communication with the first and second cavities through the passageways. A working fluid is contained in the first cavity. When the working fluid is heated, the working fluid is evaporated into vapor. The vapor passes through the passageways into the second cavity. After reaching the second cavity, the vapor is condensed into liquid state. Then, the liquid goes back into the first cavity through the passageways to complete a working cycle and achieve heat dissipation effect.

### FIELD OF THE INVENTION

The present invention relates to a heat dissipation device and a manufacturing method thereof. The heat dissipation device has higher heat conduction efficiency and better heat dissipation performance. Also, the weight of the heat dissipation device is lighter.

### BACKGROUND OF THE INVENTION

Following the continuous advance of electronic industries, it has become a very important topic how to cool or remove heat of the heat sources. To meet the requirements for high efficiency, integration and multifunctional application, it has become a great challenge how to satisfy the requirement for heat dissipation. In modern electronic industries, the research for high-efficiency heat dissipation device has been more and more respected.

Radiating fins are generally used to dissipate the heat generated by a heat generation component or system to the atmosphere. In condition of lower thermal resistance, the radiating fins have higher heat dissipation efficiency. In general, the thermal resistance is formed of the spreading thermal resistance inside the radiating fins and the convection thermal resistance between the surfaces of the radiating fins and the environmental atmosphere. In practice, the radiating fins are often made of high thermal conductivity material such as copper and aluminum so as to reduce spreading thermal resistance. However, the convection thermal resistance still limits the performance of the radiating fins. As a result, it is hard for the radiating fins to meet the heat dissipation requirement of the latest electronic components.

Accordingly, various new heat dissipation devices with higher heat dissipation efficiency, such as heat pipes, have been developed and available in the market. The heat pipes are combined with the radiating fins to solve the current heat dissipation problems.

In practice, one end of the heat pipe serves as an evaporation section connected with a heat pipe seat mounted on an electronic component. The other end of the heat pipe serves as a condensation section on which multiple radiating fins are arranged. FIG. 1 is a perspective view of a conventional heat dissipation device. The heat dissipation device 10 includes a heat sink 11 composed of multiple radiating fins and at least one heat pipe 12. One end of the heat pipe 12 is a condensation end 121, while the other end of the heat pipe 12 is an evaporation end 122. The condensation end 121 passes through the heat sink 11, while the evaporation end 122 absorbs the heat generated by the electronic component. Accordingly, when the evaporation end 122 of the heat pipe 12 is heated, the heat conduction medium contained in the evaporation end 122 absorbs a great amount of evaporation heat and is evaporated in vapor state to lower the temperature of the electronic component. When the vapor state heat conduction medium spreads to the condensation end 121 of the heat pipe 12, the heat conduction medium releases a great amount of condensation heat and is condensed into liquid state. The heat sink 11 serves to dissipate the condensation heat to outer side. The liquid state heat conduction medium then goes back to the evaporation end 122 of the heat pipe 12 under capillary attraction of the capillary structure of the heat pipe 12.

The heat sink 11 of the conventional heat dissipation device 10 is composed of multiple radiating fins through which the condensation end 121 of the heat pipe 12 extends. For achieving better heat dissipation effect, the number of the radiating fins and the number of the heat pipes must be increased. This leads to increase of volume and weight of the heat dissipation device. Moreover, the evaporation and condensation of the heat conduction medium are both completed in the heat pipe 12 so that the heat dissipation efficiency of the heat dissipation device 10 is limited. Therefore, the conventional heat dissipation device has the following shortcomings:
1. The conventional heat dissipation device has large volume and heavy weight.
2. The conventional heat dissipation device has limited heat conduction efficiency and poor heat dissipation performance.

### SUMMARY OF THE INVENTION

A primary object of the present invention is to provide a heat dissipation device and a manufacturing method thereof. The heat dissipation device has lighter weight.

A further object of the present invention is to provide the above heat dissipation device and manufacturing method thereof. The heat dissipation device has higher heat conduction efficiency and better heat dissipation performance.

To achieve the above and other objects, the heat dissipation device of the present invention includes a first chamber, a second chamber and multiple connection members. The first chamber defines therein a first cavity in which a working fluid is contained. The second chamber defines therein a second cavity. Each connection member has a first opening and a second opening at two ends. The first and second openings communicate with each other through a passageway. The first openings are connected with the first chamber. The second openings are connected with the second chamber. The first cavity of the first chamber communicates with the second cavity of the second chamber through the passageways. The working fluid in the first cavity is heated and evaporated into vapor. The vapor passes through the passageways into the second cavity. After reaching the second cavity, the vapor is condensed into liquid state. Then, the liquid goes back into the first cavity through the passageways to complete a working cycle and achieve heat dissipation effect. The heat dissipation device has much higher heat dissipation efficiency, smaller volume and lighter weight.

To achieve the above and other objects, the manufacturing method of the heat dissipation device of the present invention includes steps of: providing a first chamber defining a first cavity; providing a second chamber defining a second cavity; providing multiple connection members each defining a passageway; connecting the first and second chambers with each other by means of the connection members with the passageways in communication with the first and second cavities; providing a conduit, the conduit having a first end and a second end, the first end being exposed to outer side of the first chamber, while the second end communicating with the first cavity; evacuating air out of the first cavity, the passageways and the second cavity through the conduit and then filling working fluid into the first cavity through the conduit; and sealing the first end of the conduit. The working fluid in the first cavity is heated and evaporated into vapor. The vapor passes through the passageways into the second cavity. After reaching the second cavity, the vapor is condensed into liquid state. Then, the liquid goes back into the first cavity through the passageways to complete a working cycle and achieve heat dissipation effect. The heat dissipation device has higher heat dissipation efficiency, smaller volume and lighter weight.

According to the above, the present invention has the following advantages:
1. The heat dissipation device has smaller volume and lighter weight.
2. The heat dissipation device has higher heat conduction efficiency and better heat dissipation performance.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a conventional heat dissipation device;

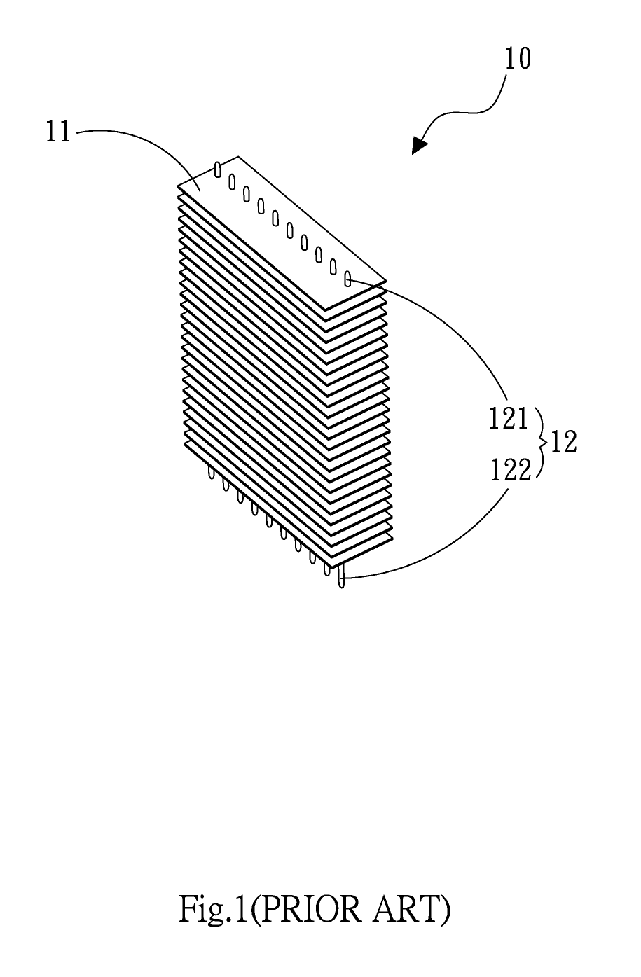

FIG. 2 is a perspective view of a first embodiment of the heat dissipation device of the present invention;

FIG. 3 is a front sectional view of the first embodiment of the heat dissipation device of the present invention;

FIG. 4 is a sectional view according to FIG. 3, showing the operation of the heat dissipation device of the present invention;

FIG. 5 is a front sectional view of a second embodiment of the heat dissipation device of the present invention;

FIG. 6 is a perspective view of a third embodiment of the heat dissipation device of the present invention;

FIG. 7A is a front sectional view of a fourth embodiment of the heat dissipation device of the present invention;

FIG. 7B is a front sectional view of a fifth embodiment of the heat dissipation device of the present invention;

FIG. 8 is a flow chart of the manufacturing method of the heat dissipation device of the present invention; and

FIG. 9 is a perspective view showing the manufacturing method of the heat dissipation device of the present invention.

### DETAILED DESCRIPTION OF THE PREFERRED EMBODIMENTS

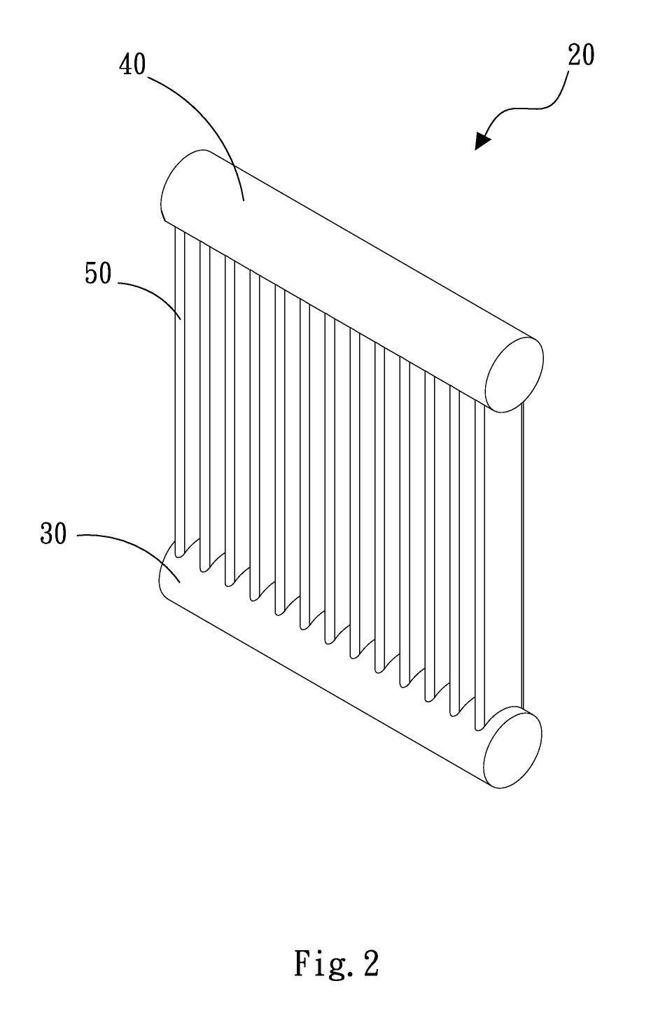

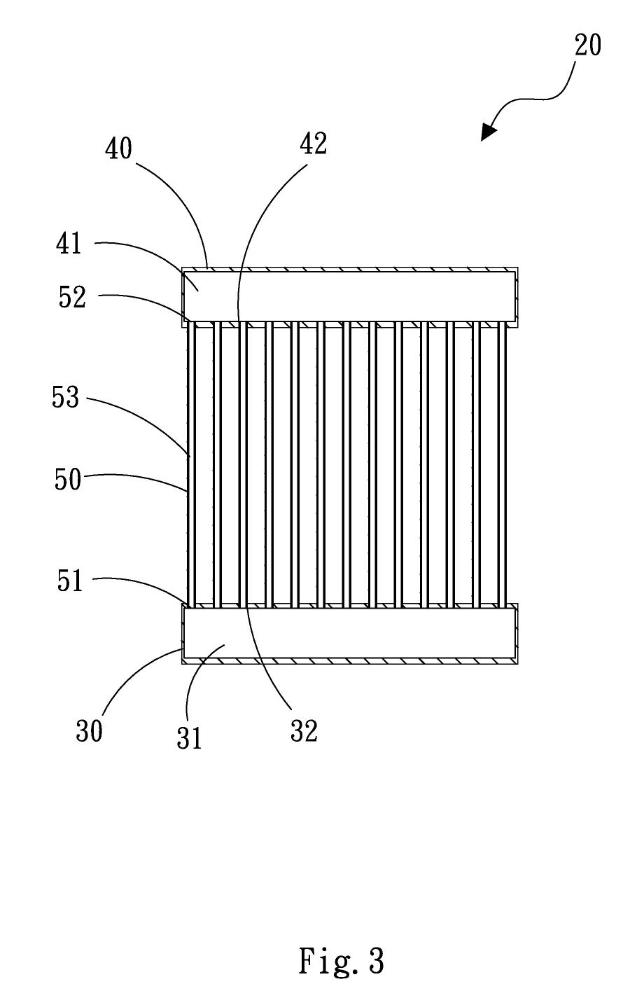

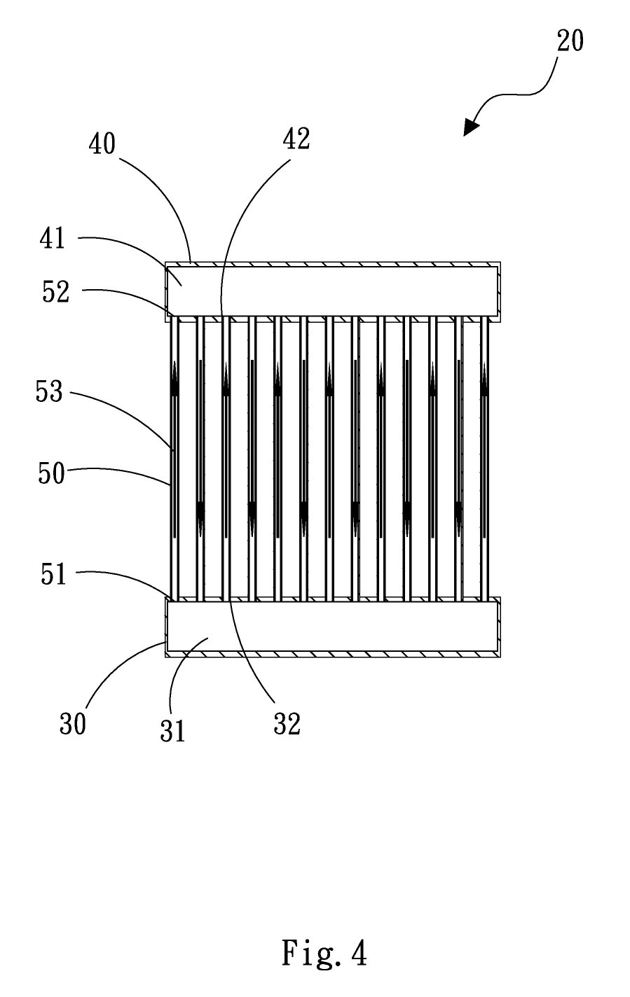

Please refer to FIGS. 2, 3 and 4. FIG. 2 is a perspective view of a first embodiment of the heat dissipation device of the present invention. FIG. 3 is a sectional view of the first embodiment of the heat dissipation device of the present invention. FIG. 4 is a sectional view according to FIG. 3, showing the operation of the heat dissipation device of the present invention. The heat dissipation device 20 of the present invention includes a first chamber 30, a second chamber 40 and multiple connection members 50.

The first chamber 30 defines therein a first cavity 31 in which a working fluid is contained. Each connection member 50 has a first opening 51 and a second opening 52 at two ends. The first and second openings 51, 52 communicate with each other through a passageway 53. The first openings 51 are connected with the first chamber 30. The first chamber 30 is formed with multiple first perforations 32 corresponding to the first openings 51 in position. The first openings 51 extend to connect with the first perforations 32, whereby the passageways 53 communicate with the first cavity 31 through the first openings 51.

The second chamber 40 defines therein a second cavity 41. The second openings 52 are connected with the second chamber 40. The second chamber 40 is formed with multiple second perforations 42 corresponding to the second openings 52 in position. The second openings 52 extend to connect with the second perforations 42, whereby the passageways 53 communicate with the second cavity 41 through the second openings 52.

According to the above arrangement, the heat dissipation device 20 is positioned in adjacency to a heat source (in contact with the heat source or not in contact therewith). In this embodiment, the first chamber 30 is a so-called evaporation end or heat absorption end. The first chamber 30 serves to absorb the heat/thermal energy dissipated from the heat source and conduct the heat/thermal energy to the second chamber 40. The second chamber 40 is a so-called condensation end or heat dissipation end. That is, when the heat source generates the heat/thermal energy, the first chamber 30 absorbs the heat/thermal energy of the heat source. At this time, the working fluid in the first cavity 31 is heated and evaporated to upward pass through at least one of the passageways 53 into the second cavity 41. After reaching the second cavity 41, the vapor releases the latent heat and is converted into liquid. Then, the liquid goes back into the first cavity 31 through the other passageways 53 to complete a working cycle and achieve heat dissipation effect.

Alternatively, the second chamber 40 is positioned in adjacency to the heat source. In this case, the second chamber 40 is the so-called evaporation end or heat absorption end, while the first chamber 30 is the so-called condensation end or heat dissipation end. This can also complete a working cycle and achieve heat dissipation effect.

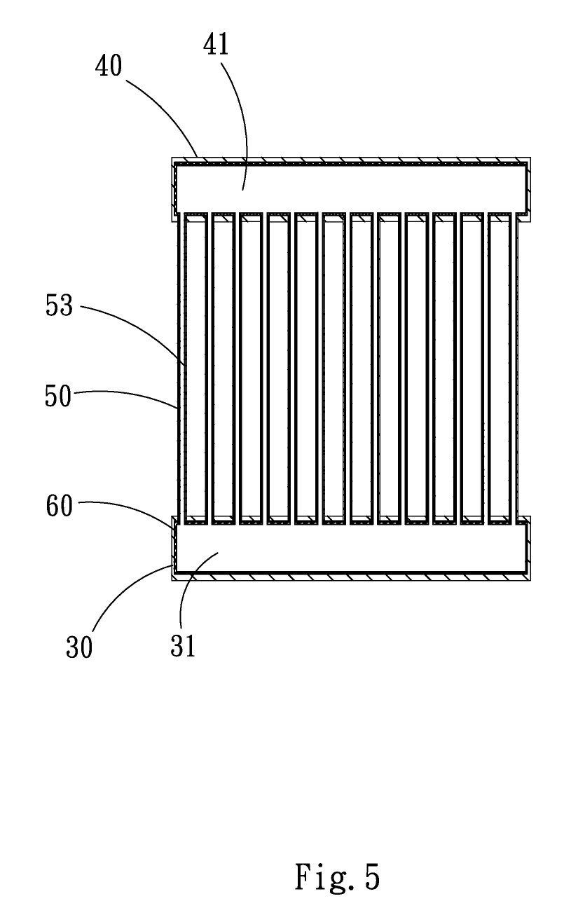

Please refer to FIG. 5, which shows a second embodiment of the heat dissipation device of the present invention. The structure and the connection relationship between the components of the second embodiment are substantially identical to that of the first embodiment and thus will not be repeatedly described hereinafter. The second embodiment is different from the first embodiment in that at least one capillary structure layer 60 is disposed on inner wall faces of the first and second chambers 30, 40 and the connection members 50. When a heat generation component generates heat, the working fluid flowing within the capillary structure layer 60 of the first chamber 30 is heated and evaporated into vapor. After reaching the second cavity 41, the vapor releases the latent heat and is converted into liquid. Then, the liquid goes back into the first cavity 31 under the capillary attraction of the capillary structure layer 60 of the second cavity 41 and the passageways 53 to complete a working cycle and achieve heat dissipation effect.

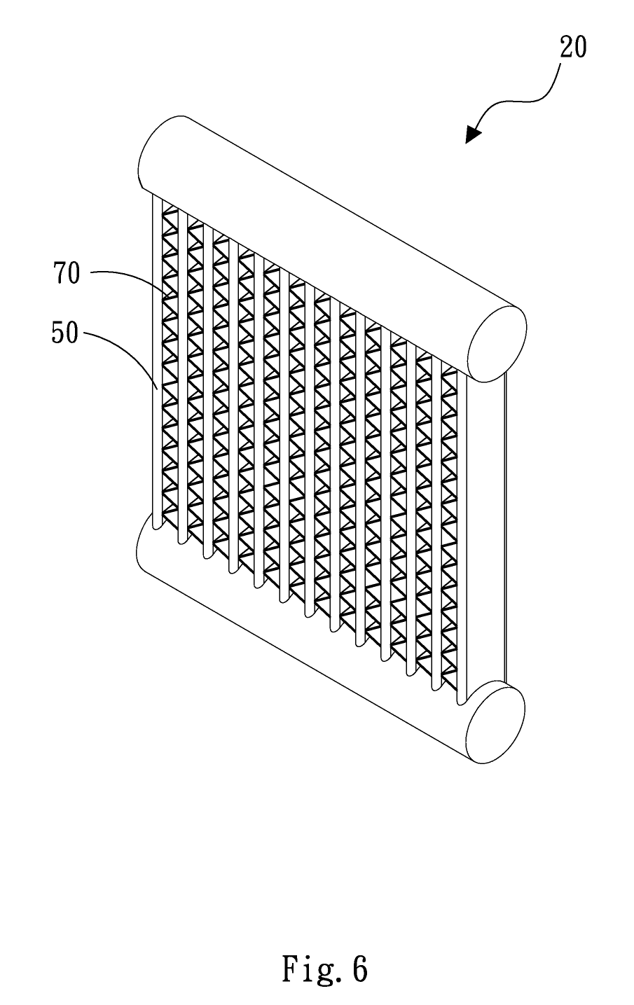

Please refer to FIG. 6, which shows a third embodiment of the heat dissipation device of the present invention. The structure and the connection relationship between the components of the third embodiment are substantially identical to that of the first embodiment and thus will not be repeatedly described hereinafter. The third embodiment is different from the second embodiment in that at least one radiating fin assembly 70 is disposed between each two adjacent connection members 50. When the vapor or liquid passes through the passageways 53 (as shown in FIG. 3), the radiating fin assembly 70 can dissipate the heat to enhance the heat dissipation effect of the heat dissipation device 20.

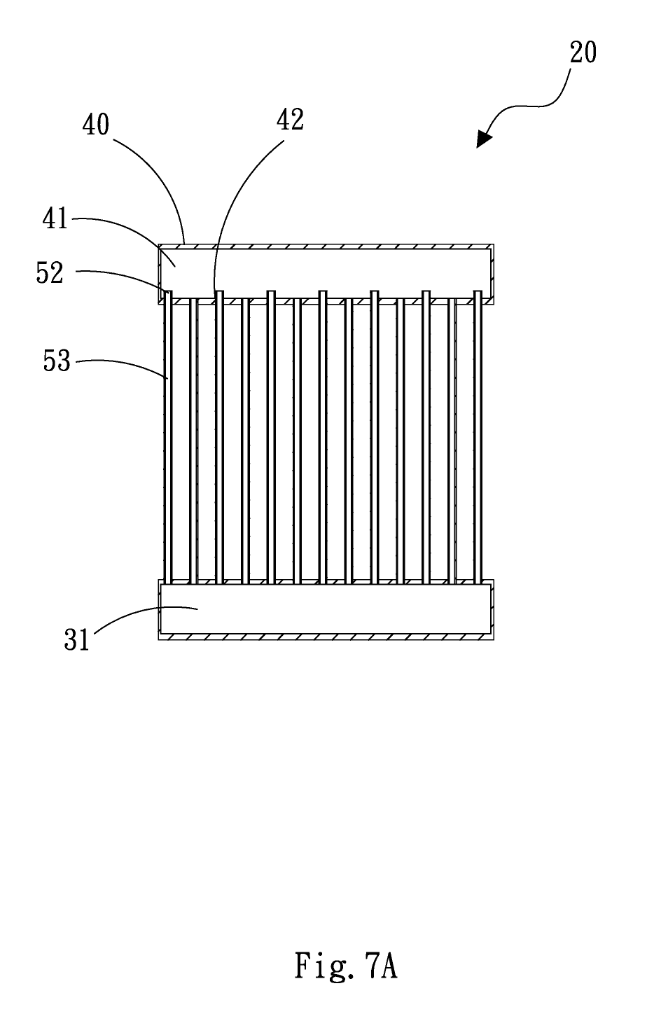

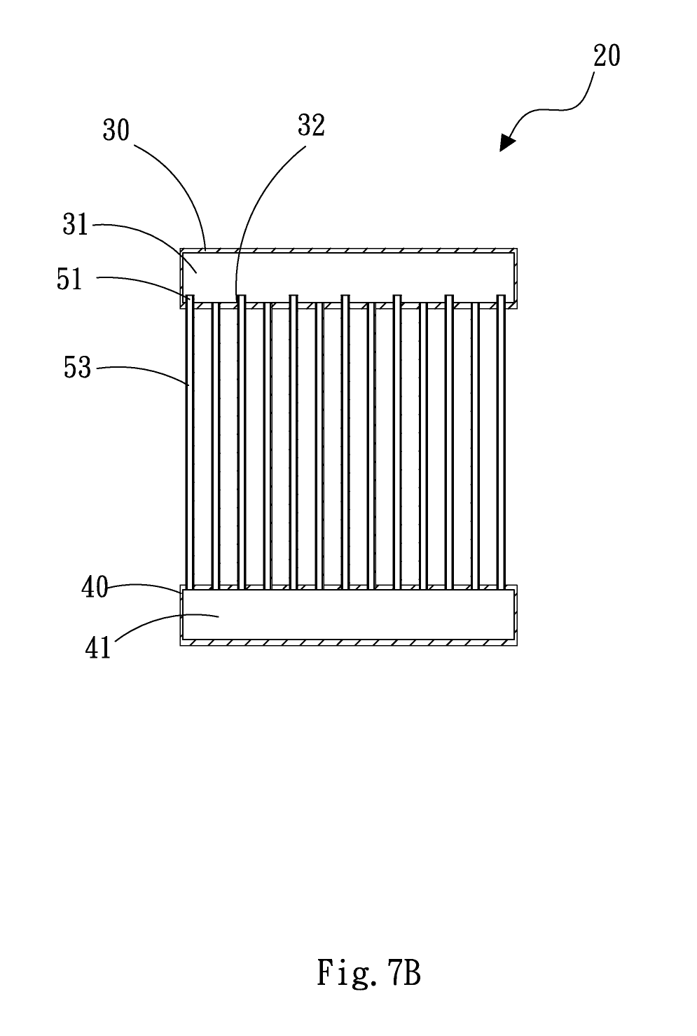

Please refer to FIG. 7A, which shows a fourth embodiment of the heat dissipation device of the present invention. The structure and the connection relationship between the components of the fourth embodiment are substantially identical to that of the first embodiment and thus will not be repeatedly described hereinafter. The fourth embodiment is different from the first embodiment in that the second openings 52 are positioned at the same height or different heights. That is, the second openings 52 of some of the passageways 53 extend through the second perforations 42 into the second cavity 41. After the working fluid in the first cavity 31 is heated and evaporated into vapor, the vapor can go into the second cavity 41 through the passageways 53 the second openings 52 of which extend into the second cavity 41. After reaching the second cavity 41, the vapor releases the latent heat and is converted into liquid. Then, the liquid flows back into the first cavity 31 through the passageways 53 the second openings 52 of which only extend to the second perforations 42. In this case, the passageways 53 for the liquid can be effectively distinguished from the passageways 53 for the vapor. FIG. 7B shows a fifth embodiment of the heat dissipation device of the present invention. In this embodiment, the second chamber 40 is positioned in adjacency to a heat source. In this case, the second chamber 40 is the so-called evaporation end or heat absorption end, while the first chamber 30 is the so-called condensation end or heat dissipation end. The first openings 51 are positioned at the same height or different heights. That is, the first openings 51 of some of the passageways 53 extend through the first perforations 32 into the first cavity 31.

After the working fluid in the second cavity 41 is heated and evaporated into vapor, the vapor can go into the first cavity 31 through the passageways 53 the first openings 51 of which extend into the first cavity 31. After reaching the first cavity 31, the vapor releases the latent heat and is converted into liquid. Then, the liquid flows back into the second cavity 41 through the passageways 53 the first openings 51 of which only extend to the first perforations 32. In this case, the passageways 53 for the liquid can be effectively distinguished from the passageways 53 for the vapor.

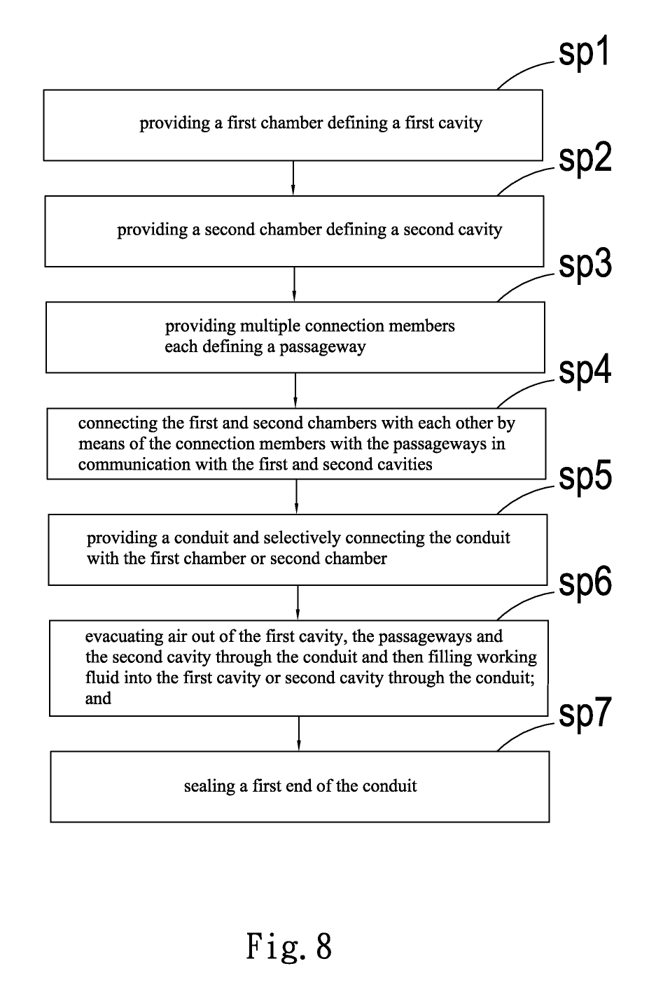

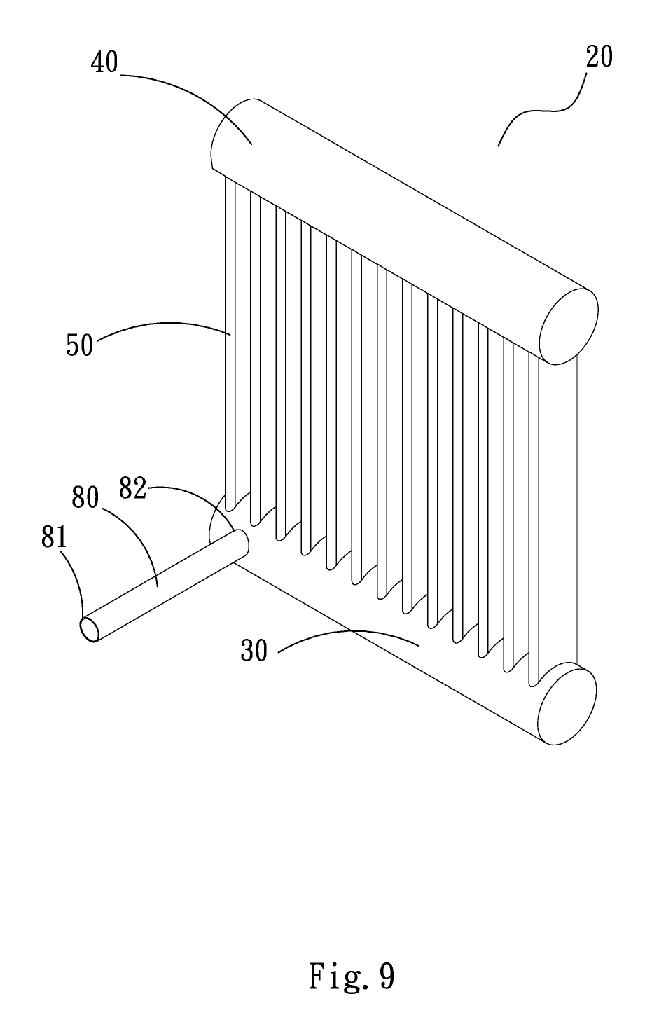

Please refer to FIGS. 8 and 9. FIG. 8 is a flow chart of a preferred embodiment of the manufacturing method of the heat dissipation device 20 of the present invention. FIG. 9 is a perspective view showing the manufacturing method of the heat dissipation device 20 of the present invention. Also referring to FIGS. 2, 3 and 4, the manufacturing method of the heat dissipation device 20 of the present invention includes:

step 1 (sp1): providing a first chamber defining a first cavity, a first chamber 30 being provided, the first chamber 30 defining an internal space as a first cavity 31, one side of the first cavity 31 being formed with multiple first perforations 32;
step 2 (sp2): providing a second chamber defining a second cavity, a second chamber 40 being provided, the second chamber 40 defining an internal space as a second cavity 41, one side of the second cavity 41 being formed with multiple second perforations 42;
step 3 (sp3): providing multiple connection members each defining a passageway, multiple connection members 50 being provided, each connection member 50 having a first opening 51 and a second opening 52 at a first end and a second end, the first and second openings communicating with each other through a passageway;
step 4 (sp4): connecting the first and second chambers with each other by means of the connection members with the passageways in communication with the first and second cavities, the first and second ends of the connection members 50 being respectively connected with the first and second chambers 30, 40 with the first openings 51 correspondingly connected with the first perforations 32 and the second openings 52 correspondingly connected with the second perforations 42, whereby the passageways 53 communicate with the first and second cavities 31, 41;
step 5 (sp5): providing a conduit and selectively connecting the conduit with the first chamber or second chamber, the conduit 80 having a first end 81 and a second end 82, in the case that the conduit 80 is connected with the first chamber 30, the first end 81 being exposed to outer side of the first chamber 30, while the second end 82 communicating with the first cavity 31, in the case that the conduit 80 is connected with the second chamber 40, the first end 81 being exposed to outer side of the second chamber 40, while the second end 82 communicating with the second cavity 41, in this embodiment, the conduit being connected with the first chamber 30;
step 6 (sp6): evacuating air out of the first cavity, the passageways and the second cavity through the conduit and then filling working fluid into the first cavity or second cavity through the conduit, the air being evacuated out of the first cavity 31, the passageways 53 and the second cavity 41 through the conduit 80 to vacuum the first cavity 31, the passageways 53 and the second cavity 41, then the working fluid being filled into the first cavity 31 or second cavity 41 through the conduit 80, in this embodiment, the working fluid being filled into the first cavity 31; and
step 7 (sp7): sealing the first end of the conduit, the first end of the conduit 80 being sealed to close the first cavity 31, the passageways 53 and the second cavity 41 in a vacuumed state.

Accordingly, the first chamber 30 is positioned in adjacency to a heat source. When the heat source generates the heat/thermal energy, the first chamber 30 absorbs the heat/thermal energy of the heat source. At this time, the working fluid in the first cavity 31 is heated and evaporated to upward pass through at least one of the passageways 53 into the second cavity 41. After reaching the second cavity 41, the vapor releases the latent heat and is converted into liquid. Then, the liquid goes back into the first cavity 31 through the other passageways 53 to complete a working cycle and achieve heat dissipation effect.

At least one capillary structure layer 60 is disposed on inner wall faces of the first and second cavities 31, 41 and the passageways 53. When a heat generation component generates heat, the working fluid flowing within the capillary structure layer 60 of the first chamber 30 is heated and evaporated into vapor. After reaching the second cavity 41, the vapor releases the latent heat and is converted into liquid. Then, the liquid goes back into the first cavity 31 under the capillary attraction of the capillary structure layer 60 of the second cavity 41 and the passageways 53 to complete a working cycle and achieve heat dissipation effect.

After the first chamber 30, the passageways 53 and the second chamber 40 are closed in a vacuumed state, the conduit 60 is removed to facilitate assembling process and use of the heat dissipation device 20.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. A heat dissipation device comprising:
a first chamber defining a first cavity;
a second chamber defining a second cavity; and
multiple connection members each having a first opening, a second opening and at least one passageway, the first and second openings communicating with the passageway, the first and second openings of the connection members being respectively connected with the first and second chambers to communicate with the first and second chambers through the passageways.

2. The heat dissipation device as claimed in claim 1, wherein the first chamber is formed with multiple first perforations corresponding to the first openings in position, the first openings extending to connect with the first perforations or extending through the first perforations into the first cavity.

3. The heat dissipation device as claimed in claim 1, wherein the second chamber is formed with multiple second perforations corresponding to the second openings in position, the second openings extending to connect with the second perforations or extending through the second perforations into the second cavity.

4. The heat dissipation device as claimed in claim 1, wherein the passageways of the connection members communicate with the first and second cavities through the first and second openings.

5. The heat dissipation device as claimed in claim 1, wherein at least one radiating fin assembly is disposed between each two adjacent connection members.

6. The heat dissipation device as claimed in claim 1, wherein at least one capillary structure layer is disposed in the first and second chambers and the connection members and a working fluid is contained in the first and second chambers and the connection members.

7. A manufacturing method of a heat dissipation device, comprising steps of:
providing a first chamber defining a first cavity;
providing a second chamber defining a second cavity;
providing multiple connection members each defining a passageway;
connecting the first and second chambers with each other by means of the connection members with the passageways in communication with the first and second cavities;
providing a conduit and selectively connecting the conduit with the first chamber or second chamber;
evacuating air out of the first cavity, the passageways and the second cavity through the conduit and then filling working fluid into the first cavity or second cavity through the conduit; and
sealing a first end of the conduit.

8. The manufacturing method of the heat dissipation device as claimed in claim 7, wherein at least one radiating fin assembly is disposed between each two adjacent connection members.

9. The manufacturing method of the heat dissipation device as claimed in claim 7, wherein at least one capillary structure layer is disposed on inner wall faces of the first and second cavities and the connection members.

10. The manufacturing method of the heat dissipation device as claimed in claim 7, further comprising a step of removing the conduit after the step of sealing the first end of the conduit.

11. The manufacturing method of the heat dissipation device as claimed in claim 7, wherein the conduit has a first end and a second end, in the case that the conduit is connected with the first chamber, the first end being exposed to outer side of the first chamber, while the second end communicating with the first cavity, in the case that the conduit is connected with the second chamber, the first end being exposed to outer side of the second chamber, while the second end communicating with the second cavity.
